(19) United States
(12) Patent Application Publication
(10) Pub. No.: US 2012/0075841 A1
(43) Pub. Date: Mar. 29, 2012

(54) LED EARRING STRUCTURE FOR BODY PIERCING JEWELRY

(75) Inventor: MYUNG SEOK HAN, Gunpo-shi (KR)

(73) Assignee: PICO BODY JEWELRY, Los Angeles, CA (US)

(21) Appl. No.: 12/916,512

(22) Filed: Oct. 30, 2010

(30) Foreign Application Priority Data
Sep. 29, 2010 (KR) 10-2010-0094173

(51) Int. Cl. F21V 21/08

(52) U.S. Cl. 362/104

(57) ABSTRACT

An LED earring structure for body piercing jewelry includes a lens unit which is installed in the front and projects emitting light outside; a light-emitting unit which flashes on and off depending on switching the power supply on and off; a power supply unit which supplies the electrical power to said light-emitting unit; an inner filler unit which wraps said light-emitting unit and said power supply unit and absorbs the impact due to the turbulence of them; a main body unit which fix said lens unit and contains and protects the emitting light unit, the power supply unit and the inner filler; and a rear assembly unit which supply the electrical power to said emitting light unit by mating with said main body unit through the pierced opening in the human body.

### TECHNICAL FIELD

This application claims the benefit of Korean patent Application No. 10-2010-0094173, filed in the Korean Intellectual Property Office on Sep. 20, 2010.

The present disclosure relates to a structure of the piercing device, and more particularly, to an LED earring structure for body piercing jewelry which can be simply and conveniently used by supplying or blocking the electrical power directly and can exert a variety of visual effects by changing the material and the shape of a light-emitting portion installed in the front.

### BACKGROUND ART

Recently, body piercing which is the practice of puncturing some parts of the human body such as ear and naval, creating an opening, in which ornaments may be worn, has been preferred in various age groups. The thickness of a piercing jewelry attached to a human body ranges from 1˜2 mm to more than 10 mm. The shapes include linear type, ring type, hooked type and the like. The material is stainless steel, Titanium, acryl, animal bones and horns, etc.

However, these conventional pierces have ever gone beyond the stage that people pierce certain parts of the human body and adorn themselves and there is a problem like that they do not meet the users' needs to express their individuality with the more diverse forms and shapes. Also, it has been a common complaint among users that they cannot check whether they showed their pierces according to personal characteristics in the night.

### SUMMARY OF THE INVENTION

An LED earring structure for body piercing jewelry of the present invention relates to an earring structure fixed to some parts of the human body and comprises a lens unit which is installed in the front and projects emitting light outside; a light-emitting unit which flashes on and off depending on switching the power supply on and off; a power supply unit which supplies the electrical power to the light-emitting unit; an inner filler unit which wraps the light-emitting unit and the power supply unit and absorb the impact due to the turbulence of them; a main body unit which fixes the lens unit and contain and protect the emitting light unit, the power supply unit and the inner filler; and a rear assembly unit which supplies the electrical power to the emitting light unit by mating with the main body unit through the pierced opening in the human body.

### ADVANTAGEOUS EFFECTS OF INVENTION

An exemplary embodiment of the present invention is advantageous in providing an LED earring structure for body piercing jewelry which users can assemble and disassemble easily for themselves.

In addition, an exemplary embodiment of the present invention is advantageous in providing an LED earring structure for body piercing jewelry with which users can express their individuality in the night or in the dark environment.

### BRIEF DESCRIPTION OF DRAWINGS

FIG. 1 is a conceptual drawing of an LED earring structure for body piercing jewelry according to one embodiment of the present invention, which shows the state before assembly.

FIG. 2 is a conceptual drawing of the LED of FIG. 1, which shows the state after assembly.

FIG. 3 is a conceptual drawing of an LED earring structure for body piercing jewelry according to another embodiment of the present invention, which shows the state before assembly.

FIG. 4 is a conceptual drawing of a power supply unit of a type that might be in the systems of FIGS. 1-3.

FIGS. 5a-5b are conceptual drawings of a portion of the LEDs shown in FIGS. 1-3, where FIG. 5a shows the state before supplying the electrical power and FIG. 5b shows the state after supplying the electrical power.

FIGS. 6a-6c are conceptual sample drawings of various embodiments of lens unit that might be used in the systems of FIGS. 1-3.

### DETAILED DESCRIPTION OF THE INVENTION

The present disclosure provides an LED earring structure for body piercing jewelry which users can assemble and disassemble easily for themselves. The present disclosure also provides an LED earring structure for body piercing jewelry that allows users to express their individuality.

An LED earring structure 100 for body piercing jewelry according to a preferred exemplary embodiment of the present invention will be explained in detail in conjunction with the figures.

A preferred exemplary embodiment of the present invention is as follows. A structure of an earring coupled to some parts of the human body comprises a lens unit which is installed in the front and projects emitting light outside; a light-emitting unit which flashes on and off depending on switching the power supply on and off; a power supply unit which supplies the electrical power to the light-emitting unit; an inner filler unit which wraps the light-emitting unit and the power supply unit and absorbs the impact due to the turbulence of them; a main body unit which fixes the lens unit and contain and protect the emitting light unit, the power supply unit and the inner filler; and a rear assembly unit which supplies the electrical power to the emitting light unit by mating with the main body unit through the pierced opening in the human body.

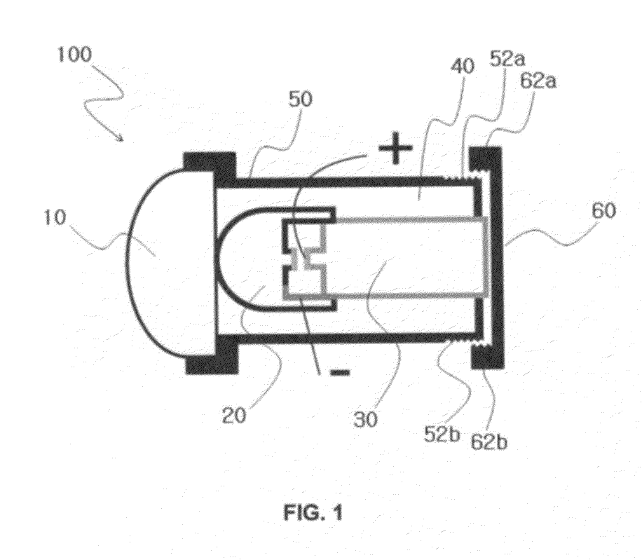

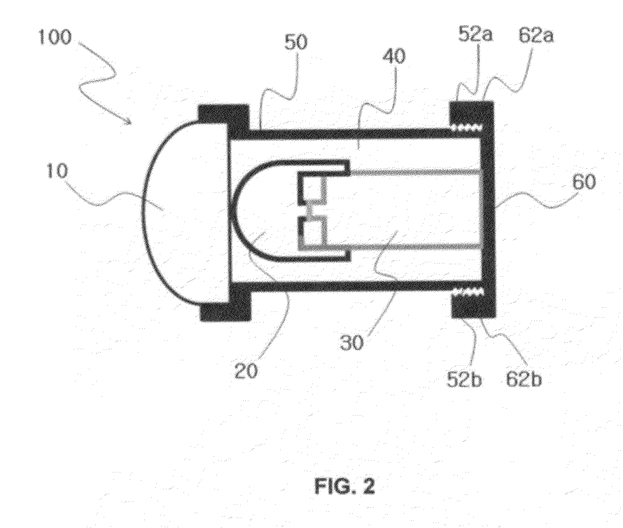

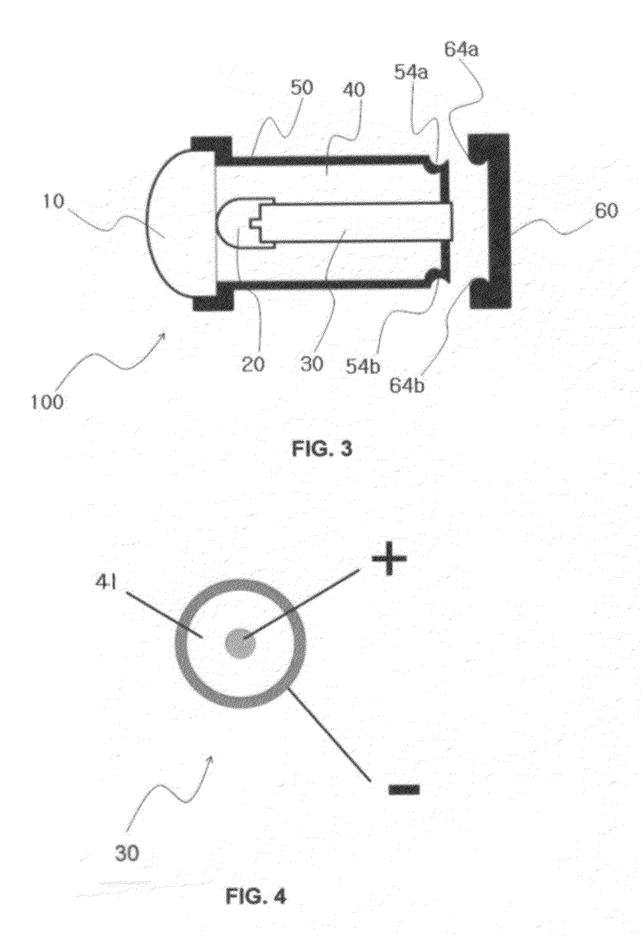

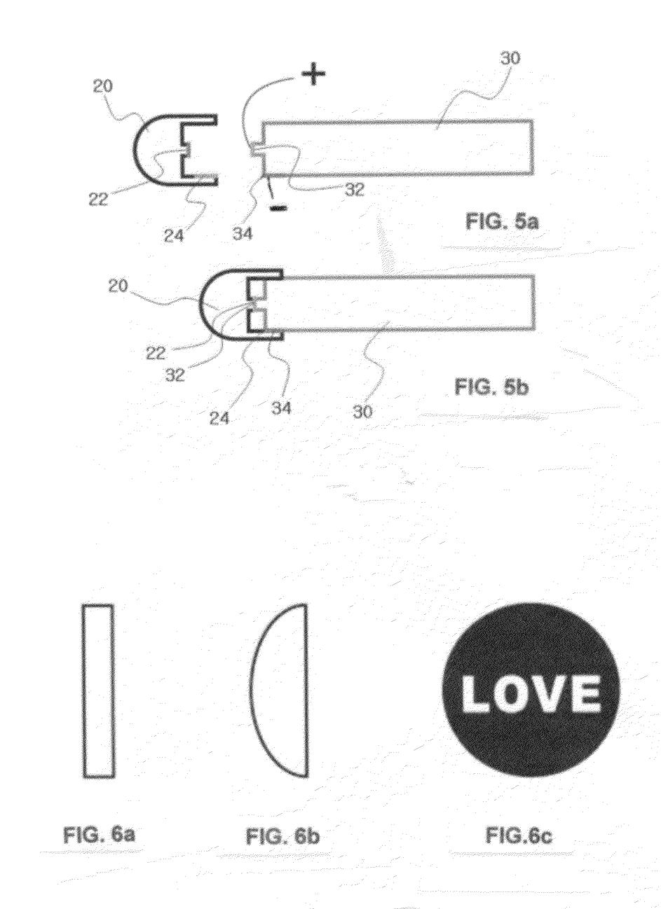

FIG. 1 is a conceptual drawing of an LED earring structure for body piercing jewelry according to an exemplary embodiment of the present invention, which shows the state before assembly, FIG. 2 is a conceptual drawing of an LED earring structure for body piercing jewelry according to an preferred exemplary embodiment of the present invention, which shows the state after assembly and FIG. 3 is a conceptual drawing of an LED earring structure for body piercing jewelry according to another preferred exemplary embodiment of the present invention, which shows the state before assembly. In addition, FIG. 4 is a conceptual drawing of an LED earring structure for body piercing jewelry according to an preferred exemplary embodiment of the present invention, which shows the configuration of a power supply unit, FIGS. 5a-5b are conceptual drawings of a portion of the LEDs shown in FIGS. 1-3, where (a) shows the state before supplying the electrical power and (b) shows the state after supplying the electrical power, and FIGS. 6a-6c are conceptual sample drawings of various embodiments of lens unit that might be used in the systems of FIGS. 1-3, respectively.

First, referring to significant reference numbers in FIG. 1 and explaining the LED earring structure for body piercing jewelry, the reference number 10 is a lens unit which is installed in the front and directs the light emitted by an LED. The reference number 20 is a light-emitting unit using an LED, wherein red, green, blue and white LED diodes can be adopted according to users' preferences or options. The LED light-emitting unit comprises an LED anode terminal 22 and an LED cathode terminal 24, which make current flow in the inside of the LED.

The reference number 30 is a power supply unit which supplies the electrical power to the light-emitting unit 20 and comprises a battery. The power supply unit 30 comprises a conventional battery cell with a positive electrode 32 (+) and a negative electrode 34 (−). In this exemplary embodiment, the light-emitting unit and power supply unit comprise one LED device and one battery cell, respectively. Optionally, a plurality of LED devices and a plurality of battery cells can be additionally configured.

Next, the reference number 40 is an inner filler unit comprising an insulating filler which wraps the light-emitting unit 20 and the power supply unit 40 and absorbs the impact due to the turbulence of them.

The reference number 50 illustrates a main body unit which holds the lens unit 10 and houses the emitting light unit 20, the power supply unit 30 and the inner filler 40. On one end portion of the main body unit 50, a screw-thread-typed fastening structure 52a, 52b, is formed.

The reference number 60 illustrates a rear assembly unit which supplies the electrical power to the emitting light unit 20 by fixing and mating with the main body unit 50 in the backside after the user inserts the main body through the opening pierced in her body. The reference numbers 62a, 62b illustrate a rear female fastening structure which is formed on both sides of the rear assembly unit 60 and can detachably engage the male fastening structure 52a, 52b.

The configuration described above forms an LED earring structure 100 for body piercing jewelry according to a preferred exemplary embodiment of the present invention.

In the following part, with reference to FIG. 1 and FIG. 2, a specific example of an LED earring structure 100 for body piercing jewelry according to one embodiment of the present invention will be described.

FIG. 1 and FIG. 2 illustrate the states that a power supply unit 30 comprising a battery is separated from a rear assembly unit 60 and the state that a power supply unit is coupled to a rear assembly unit, respectively. In FIG. 1, the electrical power to the light-emitting unit 20 is blocked because a male fastening structure 52a, 52b formed on one end of a main body unit 50 is separated from a rear female fastening structure 62a, 62b formed on a rear assembly unit 60. As depicted in FIG. 2, the light-emitting unit 20 is powered up and emits the light when a male fastening structure 52a, 52b formed on one end of the main body unit 50 is closely coupled with a rear female fastening structure 62a, 62b formed on a rear assembly unit 60. A male fastening structure 52a, 52b formed on one end of the main body unit 50 is inserted through an opening pierced in the ear. The electrical power is supplied or blocked as a rear female fastening structure 62a, 62b formed on a rear assembly unit 60 is separated from or coupled with a male fastening structure 52a, 52b in the backside of the ear. Therefore, the LED earring structure 100 for body piercing jewelry can be switched on and off depending on the user's coupling or removing action. In this case, users can express their individuality effectively by wearing an LED pierce in the night or in the dark environment,

Next, FIG. 3 shows a main body unit 50 according to another exemplary embodiment of the present invention. As depicted, a main body concave part 54a, 54b is formed on one end of the main body unit 50 and a rear convex part 64a, 64b formed on a rear assembly part 60 can mate with the convex surface. Users can wear the LED earring by engaging a main body concave part 54a, 54b with a rear convex part 64a, 64b in the backside of the ear after inserting the main body concave part 54a, 54b into an opening pierced in the ear. It should be apparent to those of ordinary skill in the art that there can be other suitable variations in the fastening structure through some parts of a user's body.

FIG. 4 shows a specific structure of a power supply unit 30. As depicted, a positive electrode of a power supply comprising a battery is formed in the center, while a negative electrode is formed around an inner insulating filler 41 filled between the positive and negative electrodes.

Next, referring to FIGS. 5a-5b and FIGS. 6a-6c, in an LED earring structure 100 for body piercing jewelry according to one embodiment of the present invention, the configuration and operation for supplying and blocking the electrical power will be described in detail. As depicted in FIG. 5a, a positive electrode (+) and a negative electrode (−) formed on a power supply unit 30 are separated from an LED anode terminal 22 and an LED cathode terminal 24 respectively. When users fasten a rear assembly unit, a power supply unit comprising a battery is pushed to the left to contact a light-emitting unit, as depicted in FIG. 5b.

As an LED anode terminal 22 formed on an LED device contacts a positive electrode (+) formed on a power supply unit 30 and an LED cathode terminal 24 contacts a negative electrode (−) formed on a power supply unit 30, an LED device is powered. When the user unfastens a rear assembly unit 60 after wearing an earring, the power supply is shut off and a light-emitting unit (20) is turned off.

FIGS. 6a-6c illustrate some variations of a lens unit 10 disposed in the front of an LED earring structure 100 for body piercing jewelry according to the present invention. FIG. 6a shows a shape of a conventional plain lens, FIG. 6b shows a shape of a convex lens which has a visual effect by diffusing light, and FIG. 6c shows a shape of a letter sticker. Especially, in FIG. 6c, by attaching a sticker with white letters on a black background to the inside of a lens unit 10, the user can have a wide range of options to vary colors and letters and express the most of her individuality.

As disclosed above, in an LED earring structure 100 for body piercing jewelry according to one embodiment of the present invention, a lens unit 10 may comprise any one or the combination of more than one among a plain transparent lens, a removable sticker, a hemisphere convex lens and an optical fiber. And, the inner filler 40 may be formed of any one or the combination of epoxy and acrylic material. Any material which can protect the contained components from impact and electrically insulate can be adopted.

In addition, the main body unit 50 is made of any one or the combination of acrylic material, surgical stainless steel, and titanium and has a cylindrical shape corresponding to the shape of a power supply unit comprising a battery. The diameter of a main body is about 3˜50 mm, even though there is no limit in the shape or the kind of material.

The rear assembly unit 60 comprises either a thread-type fastening structure with screw threads or a snap-type fastening structure. It should be apparent to those of ordinary skill that any suitable user-friendly fastening structure for an easy separation and removal can be applicable.

The lens unit 10 is characterized by attaching or forming user's favorite letters or figures inside and hence may comprise various shapes and kinds of material according to user's individuality and preference.

Although the present disclosure has been described in terms of specific embodiments thereof, it should be understood that numerous other modifications and embodiments can be devised by those skilled in the art that will fall within the sprit and scope of the principles of this closure.

1. An LED earring structure for body piercing jewelry, comprising:
a lens unit adapted to direct light and including a hemispherical convex lens having a surface that forms a portion of an external surface of said LED earring structure;
a light-emitting unit for flashing on and off;
a power supply unit for supplying electrical power to said light-emitting unit;
an inner filler unit for wrapping said light-emitting unit and said power supply unit and for protecting said light-emitting unit and said power supply unit from an external impact;
a main body unit for holding said lens unit and housing said light-emitting unit, the power supply unit and the inner filler; and
a rear assembly unit adapted to mate with said main body unit through a pierced opening in a human body.

2. The LED earring structure of claim 1, wherein said lens unit further includes a removable sticker attached to an inside of said hemispherical convex lens.

3. The LED earring structure of claim 1, wherein said inner filler comprises one or a combination of epoxy and acrylic material.

4. The LED earring structure of claim 1, wherein said main body unit is made of one or a combination of acrylic material, surgical stainless steel, and titanium.

5. The LED earring structure of claim 1, wherein said rear assembly unit includes a thread-type fastening structure with screw threads or a snap-type fastening structure.

6. The LED earring structure of claim 1, further comprising a user's favorite letter or a figure disposed inside.
